(19) United States
(12) Patent Application Publication
(10) Pub. No.: US 2007/0016693 A1
(43) Pub. Date: Jan. 18, 2007

(54) Decompression technique for generating software image

(75) Inventor: Steven Goodrich, Longmont, CO (US)

Correspondence Address: HAMILTON & TERRILE. LLP, P.O. BOX 203518, AUSTIN, TX, 78720, US

(73) Assignee: Advanced Micro Devices, Inc., Sunnyvale, CA (US)

(21) Appl. No.: 11/172,509

(22) Filed: Jun. 30, 2005

(51) Int. Cl. G06F 15/16

(52) U.S. Cl. 709/247

(57) ABSTRACT

An improved compression and decompression technique to maximize the utilization of low capacity data storage while minimizing the decompression time. In one embodiment, software files comprising a file header and a plurality of records are compressed to generate a compressed file header and a single record that contains a compressed image of the original plurality of records. Upon execution, the record is decompressed and portions of the compressed images corresponding to destination addresses are decompressed to allow a decompressor to directly place the decompressed records in the desired destination. In another embodiment of the invention, software files comprising a file header and a plurality of records are individually compressed to generate a compressed file header and a plurality of compressed records. Upon execution, the file header and portions of the individual records corresponding to destination address are decompressed to allow a decompressor to directly place the individual records into the desired destination. The various embodiments of the present invention can be used to compress and decompress software images stored in low-capacity nonvolatile storage devices including, but not limited to compact flash memory cards and low-capacity hard drives. Since the individual records are directly decompressed to the desired memory locations, execution time is decreased thereby providing improved performance.

### BACKGROUND OF THE INVENTION

1. Field of the Invention

The present invention relates to the field of information processing systems. In one aspect, the present invention relates to an improved method and apparatus for compressing and decompressing software images for information processing systems.

2. Description of the Related Art

Computer systems have attained widespread use for providing information management capability to many segments of today's society. A personal computer system can usually be defined as a microcomputer that includes a system unit having a system processor and associated volatile and non-volatile memory, a display monitor, a keyboard, a fixed disk storage device, an optional removable storage device and an optional printer. These personal computer systems are information processing systems which are designed primarily to give independent computing power to a single user (or a group of users in the case of personal computers which serve as computer server systems) and are inexpensively priced for purchase by individuals or small businesses.

In recent years, there has been significant growth in the use of the personal computers to exchange information over the Internet. This exchange of information is based on a client/server model with the user's personal computer operating as the client to access data stored on a plurality of Internet servers. Some Internet service providers provide a computer to a user as part of a contractual relationship to provide Internet service. As part of the relationship, the Internet service provider will typically provide a customized software package that is tailored to a particular group of users.

As the Internet use grows in low-income countries, there is a need to provide a low-cost computing device for use as a personal internet communicator (PIC). Some low-cost computing devices use low-capacity, nonvolatile memory to store operating system and software application files. It is desirable, therefore, to compress these files to maximize the utilization of the memory. File compression is also used to maximize storage on low-cost, low-capacity hard drives.

While the compression technique provides increased efficiency in the utilization of storage capacity, current decompression techniques are comparatively inefficient. For example, current decompression techniques generally require the entire software image to be decompressed into memory with a subsequent processing step to copy the decompressed files to their intended destination. Consequently, there is a need for an improved method and apparatus for compressing and decompressing software files for storage in low-capacity memory devices used in low-cost computing devices.

### SUMMARY OF THE INVENTION

The method and apparatus of the present invention provides an improved compression and decompression technique to maximize the utilization of low capacity data storage while minimizing the decompression time. In one embodiment of the invention, software files comprising a file header and a plurality of records are compressed to generate a compressed file header and a single record that contains a compressed image of the original plurality of records. Upon execution, the record is decompressed and portions of the compressed images corresponding to destination addresses are decompressed to allow a decompressor to directly place the decompressed records in the desired destination.

In another embodiment of the invention, software files comprising a file header and a plurality of records are individually compressed to generate a compressed file header and a plurality of compressed records. Upon execution, the file header and portions of the individual records corresponding to destination address are decompressed to allow the decompressor to directly place the individual records into the desired destination.

The various embodiments of the present invention can be used to compress and decompress software images stored in low-capacity nonvolatile storage devices (including, but not limited to compact flash memory cards and low-capacity hard drives). Since the individual records are directly decompressed to the desired memory locations, execution time is decreased thereby providing improved performance.

The objects, advantages and other novel features of the present invention will be apparent to those skilled in the art from the following detailed description when read in conjunction with the appended claims and accompanying drawings.

### BRIEF DESCRIPTION OF THE DRAWINGS

FIG. 1 is a block diagram of a plurality of computer systems communicating over one or more communication networks.

FIG. 2 is a system block diagram of a computer system, such as a personal Internet communicator, in accordance with various embodiments of the present invention.

FIG. 3 shows a block diagram of a processor system for use in the personal Internet communicator.

FIG. 4 is an illustration of the file structure of a software image and a corresponding file structure for a compressed software image in accordance with an embodiment of the invention.

FIG. 5 is an illustration of the file structure of a software image and a corresponding file structure for a compressed software image in accordance with a second embodiment of the invention.

FIG. 6 is a flowchart illustration of the processing steps for implementing an embodiment of the method of the present invention.

### DETAILED DESCRIPTION

While illustrative embodiments of the present invention are described below, it will be appreciated that the present invention may be practiced without the specified details, and that numerous implementation-specific decisions may be made to the invention described herein to achieve the developer's specific goals, such as compliance with system-related and business-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid obscuring or unduly limiting the present invention. Such descriptions and representations are used by those skilled in the art to describe and convey the substance of their work to others skilled in the art. The present invention will now be described with reference to the drawings described below.

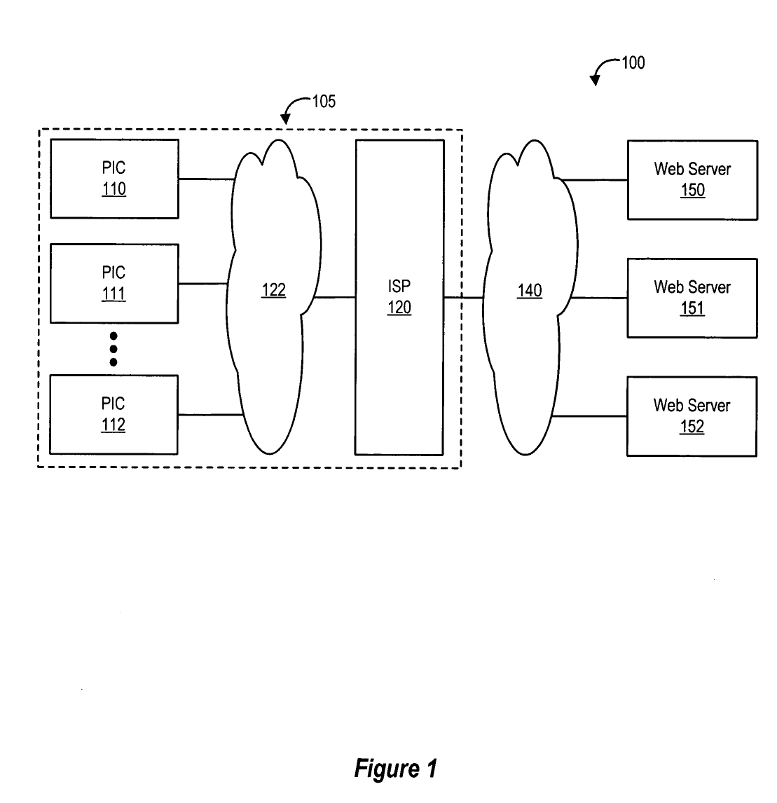

Referring to FIG. 1, a block diagram of an exemplary network 100 is shown wherein a plurality 105 of computer systems 110, 111, 112 communicates over one or more communication networks 140. As illustrated, each computer system (e.g., 110)—also referred to as a multimedia access devices or personal Internet communicators (PICs)—is operably coupled to an Internet service provider (ISP) 120 via one or more communication links 122. The Internet service provider 120 is coupled to the Internet 140 that is further coupled to a plurality of Web host servers 150, 151, 152. A user wishing to access information on the Internet uses a PIC (e.g., 110) to execute an application program stored on the PIC known as a Web browser.

The PIC 110 includes communication hardware and software that allows the PIC 110 to send and receive communications to and from the Internet service provider 120. The communications hardware and software allows the PIC 110 to establish a communication link with the Internet service provider 120. The communication link may be any of a variety of connection types including a wired connection, a direct link such as a digital subscriber line (DSL), Ti, integrated services digital network (ISDN) or cable connection, a wireless connection via a cellular or satellite network, phone modem dialup access or a local data transport system, such as Ethernet or token ring over a local area network.

When the customer enters a request for information by entering commands in the Web browser, the PIC 110 sends a request for information, such as a search for documents pertaining to a specified topic, or a specific Web page to the Internet service provider 120 which in turn forwards the request to an appropriate Web host server 150 via the Internet 140. The Internet service provider 120 executes software for receiving and reading requests sent from the browser. The Internet service provider 120 executes a Web server application program that monitors requests, services requests for the information on that particular Web server, and transmits the information to the user's PIC 110.

Each Web host server 150, 151, 152 on the Internet has a known address that the user supplies to the Web browser to connect to the appropriate Web host server. If the information is not available on the user's Web host server 150, the Internet 140 serves as a central link that allows Web servers 150, 151, 152 to communicate with one another to supply the requested information. Because Web servers 150, 151, 152 can contain more than one Web page, the user will also specify in the address which particular Web page he wants to view. The address, also known as a universal resource locator (URL), of a home page on a server is a series of numbers that indicate the server and the location of the page on the server, analogous to a post office address. For simplicity, a domain name system was developed that allows users to specify servers and documents using names instead of numbers. A URL may further specify a particular page in a group of pages belonging to a content provider by including additional information at the end of a domain name.

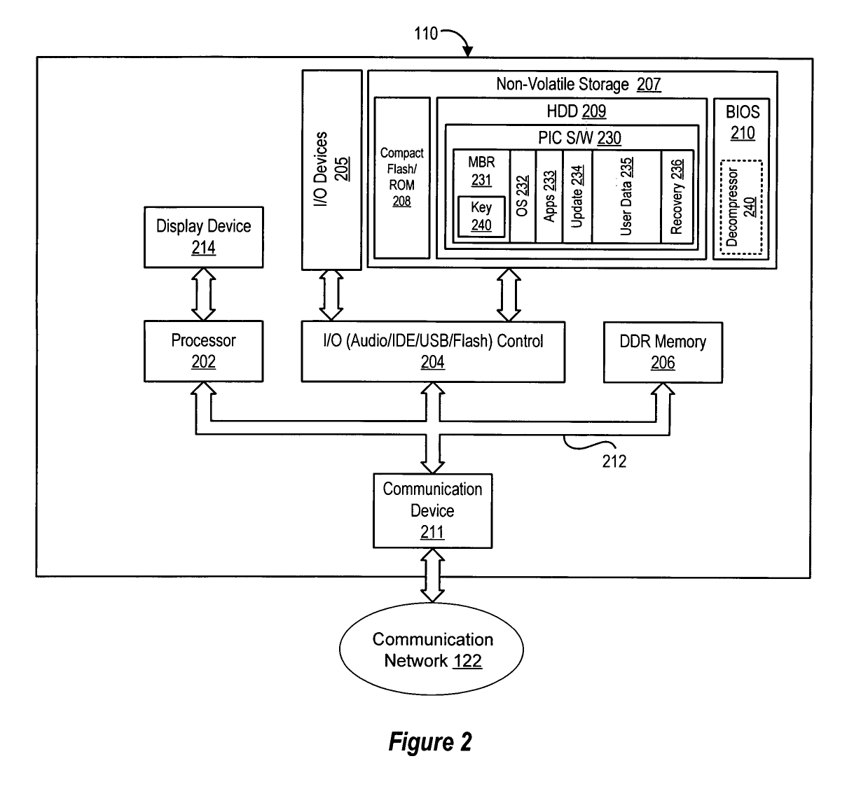

Referring to FIG. 2, a block diagram of PIC 110 is shown. The PIC 110 includes a processor 202, input/output (I/O) control device 204, memory (including volatile random access memory (RAM) memory 206 and non-volatile memory 207), communication device 211 (such as a modem) and a display 214. The processor 202, I/O controller 204, memory 206 and communication device 211 are interconnected via one or more buses 212. In a selected embodiment, the processor 202 is implemented as an AMD Geode GX 32-bit x86 compatible processor, the memory 206 is implemented as a 128 MB DDR memory and the display 214 is implemented as a CRT monitor. In addition, the non-volatile memory 207 may include a hard disk drive 209 that is implemented as an integrated 3.5 inch hard disk drive with a minimum capacity of, e.g., 10 GB. Either or both of the memories 206, 207 may be integrated with or external to the PIC 110. As for the communication device 211, an integrated 56K ITU v. 92 Modem with an external connector may be used to support different phone systems throughout the world, though other modems (e.g., a soft modem) may also be used. Of course, it will be appreciated that other device configurations may also be used for the processor 202, memory 206, 207, display 214 and communication device 211. For clarity and ease of understanding, not all of the elements making up the PIC 110 are described in detail. Such details are well known to those of ordinary skill in the art, and may vary based on the particular computer vendor and microprocessor type. Moreover, the PIC 110 may include other buses, devices, and/or subsystems, depending on the implementation desired. For example, the PIC 110 may include caches, modems, parallel or serial interfaces, SCSI interfaces, network interface cards, and the like.

As illustrated in FIG. 2, the I/O control device 204 is coupled to I/O devices 205, such as one or more USB ports, a keyboard, a mouse, audio speakers, etc. The I/O control device 204 is also coupled to non-volatile storage 207, such as a compact flash memory or other read only memory (ROM) 208 and/or hard disk drive 209. In various embodiments of the invention, various components of the nonvolatile storage 207, such as the compact flash 208 or the hard disk 209 can store compressed images of the operating system and other software files. The decompressor 240 in the BIOS 210 can be used to decompress these software images and to store the decompressed files directly in their intended destinations, as discussed hereinbelow.

The PIC 110 is depicted as being connected to communication network 122 and the Internet 140 by a communication device 211, such as a modem, but the connection may be established by any desired network communication device known to those of skill in the art. Though the processor 202 is shown as being coupled directly to a display device 214, the processor may also be coupled indirectly to the display 214 through a display or I/O controller device. Similarly, the processor is shown as being coupled through the I/O controller 204 to the non-volatile memory 207, though direct coupling is also contemplated.

Various programming codes and software are stored in the PIC memory. For example, the basic input/output system (BIOS) code that starts the PIC 110 at startup may be stored in a BIOS ROM device 210 of the non-volatile storage 207, such as a ROM (Read Only Memory) or a PROM (Programmable ROM) such as an EPROM (Erasable PROM), an EEPROM (Electrically Erasable PROM), a flash RAM (Random Access Memory) or any other type of memory appropriate for storing BIOS. The BIOS/Bootloader 210 is essentially invisible to the user and includes a compatible bootloader to enable the PIC operating system to be an embedded closed operating system, such as a Windows CE type operating system, though any operating system (including but not limited to Windows-based and Linux-based Operating Systems) could be supported by the BIOS code. The BIOS/Bootloader 210 is essentially invisible to the user and boots to the operating system.

PIC software 230 and user data may also be stored on the hard drive 209 of the non-volatile storage 207 and executed and/or processed by processor 202. The PIC software 230 may include a master boot record (MBR) 231, an operating system 232, an application program partition 233, a software update module 234, user data 235, and a hidden image recovery module 236. The MBR 231 is the first sector (512 bytes long in some systems) on the hard drive 209. This sector contains bootstrap code and a partition table. The bootstrap code is executed when the PIC 110 boots up. As for the operating system, several uniquely configurable operating parameters that can affect the performance of the system are pre-configured as part of the software 230 when it is initially installed on the drive 209. The software 230 also includes application programs 233 that are needed for the PIC 110 to function as specified. For example, the applications 233 may include web browser, Flash player, presentation viewer for PowerPoint, chat, game, compression utility, e-mail, word processor, spreadsheet, PDF viewer, media player and/or drawing applications. In addition, the user data 235 stores all of the user's data so that a user has direct access to the user data. This user data is protected from the rest of the operating system to prevent corruption of the data by a virus or other means.

In a selected embodiment, the PIC 110 is protected against unauthorized installations by configuring the PIC software 230 so that applications are added or updated only from boot loader devices that have a predetermined authorization or security key. An example of such a boot loader device is a USB-connected flash storage device. In an example implementation, the installation restriction is controlled by the software update module 234 which only allows installations from boot devices having a key that matches a locally stored installation key, such as a unique security key 240 that is stored in the non-volatile memory 207. The unique security key 240 may be unique for each PIC 110, 111, 112, or may instead shared among the PICS to collectively control installation access from a single source (e.g., ISP 120). In a selected embodiment, the unique security key 240 is stored in the master boot record 231 of the hard drive 209, although it may also be stored in the flash memory or other ROM 208 or on a hardwired integrated circuit. Thus, before any operating system files or application files are transferred from the bootable device, the update module 234 must determine that the boot device has a signature or key that matches or otherwise corresponds to the unique security key 240. In this way, the unique security key 240 can be used to protect the integrity of the operating system on the PIC 110 by restricting installation of operating system code or other software to bootable devices that have a matching security key.

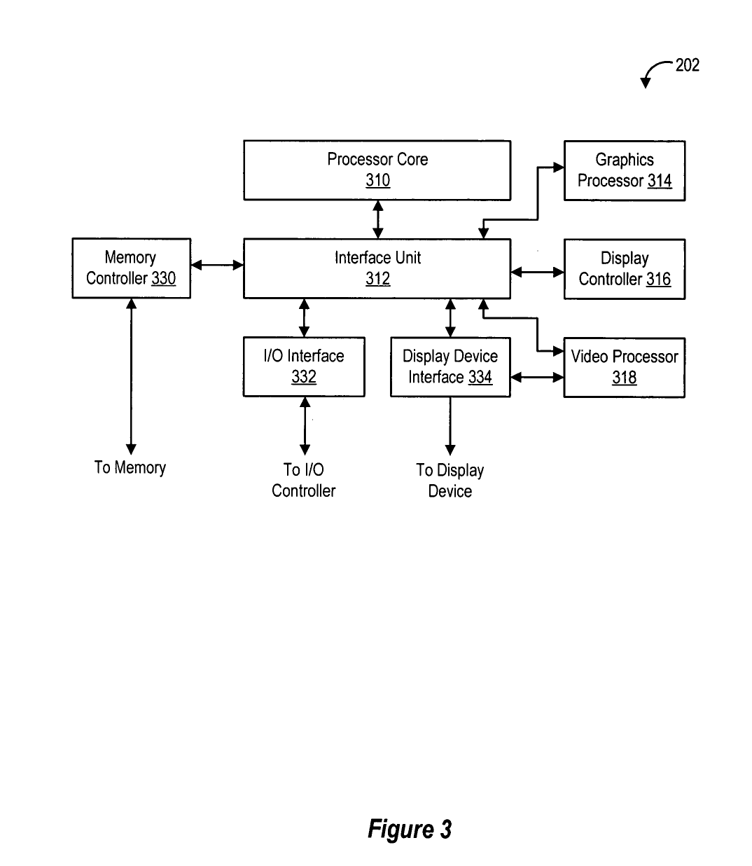

Referring to FIG. 3, a block diagram of the processor 202 is shown. In one embodiment, the processor 202 is a Geode GX2 processor available from Advanced Micro Devices. The processor 202 includes a processor core 310, a bus or interface unit 312, a graphics processor 314, a display controller 316, and a video processor 318. The processor 202 also includes a memory controller 330, an I/O controller interface 332 and a display device interface 334, though it will be appreciated that these controllers and interfaces may be implemented externally to the processor 202. In the illustrated embodiment, the processor 202 executes software stored in the memory 206, 207 to restrict installation of operating systems and other software from boot devices that do not include an authorized signature that matches or corresponds to the unique security key 240.

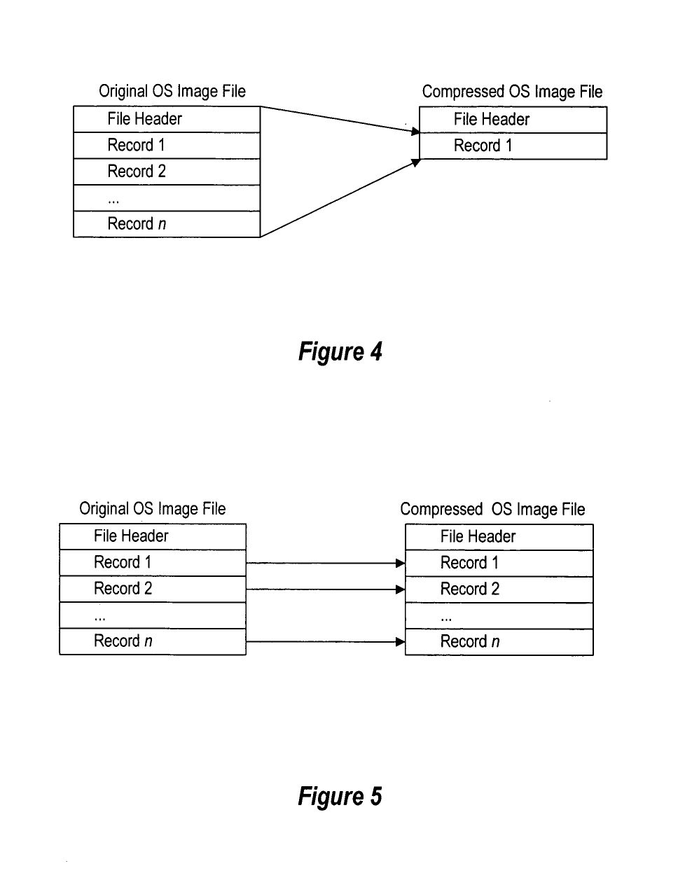

FIG. 4 is an illustration of the file structure of a software image and a corresponding file structure for a compressed software image in accordance with a first embodiment of the invention. The software image shown in FIG. 4 is comprises a structure used for many operating system images, such as the Windows CE operating system (OS). The image files are stored in a single monolithic file which follows a predefined structure using a format comprising a file header (FH) that contains a signature, the address at which the image starts to be loaded, and the total length of the image file. Each record in the file (Record 1, Record 2, . . . , Record n) comprises a header followed by the record's data payload. The record header (RH) contains the destination address of the data, the length of the data, and a validation code, that may be a checksum, used to validate the contents of the record's data.

In the present invention, the record-based format of the OS image file is combined with the a record-based compression mechanism to reduce the media space required for storing an OS image file and also to reduce the time required to transfer OS image files from one storage medium (Internet server, file server, hard drive, memory, etc.) to another.

The present invention comprises two embodiments that are operable to generate a compressed OS Image File which will still be recognized by the tools that manipulate OS image files. In the first embodiment, illustrated in FIG. 4, the OS image is compressed to generate a new file which contains an FH and a single record. The record contains a compressed version of the original OS Image. This embodiment of the invention can result in approximately a 50% decrease in image size and transfer time, depending on the contents of the image.

FIG. 5 is an illustration of the file structure of a software image and a corresponding file structure for a compressed software image in accordance with a second embodiment of the invention. In this embodiment of the invention the OS image is compressed to generate a new file which contains a file header and multiple records. Each record would contain a compressed version of its corresponding record from the original image. This embodiment of the invention results in roughly a 40% decrease in image size and transfer time, depending on the contents of the image. In addition, it allows for greater flexibility by allowing selective compression of individual records.

Generation of the compressed OS image file can be implemented in a post-processing step once the original image had been generated by the operating system builder. The compressed image is decompressed by the decompressor 240 in the BIOS 210 as illustrated in FIG. 2. Depending on the embodiment of the invention used to compress the OS image file, one of two methods may be used to decompress the image and being execution: 1) Copy the entire image into RAM, decompress the entire image at once, and then walk the in-memory decompressed image to place the pieces into their target locations, or 2) Uncompress a small portion of the image (enough to know where the uncompressed data is going to be placed), then decompress it to its target location. This is repeated for all the records.

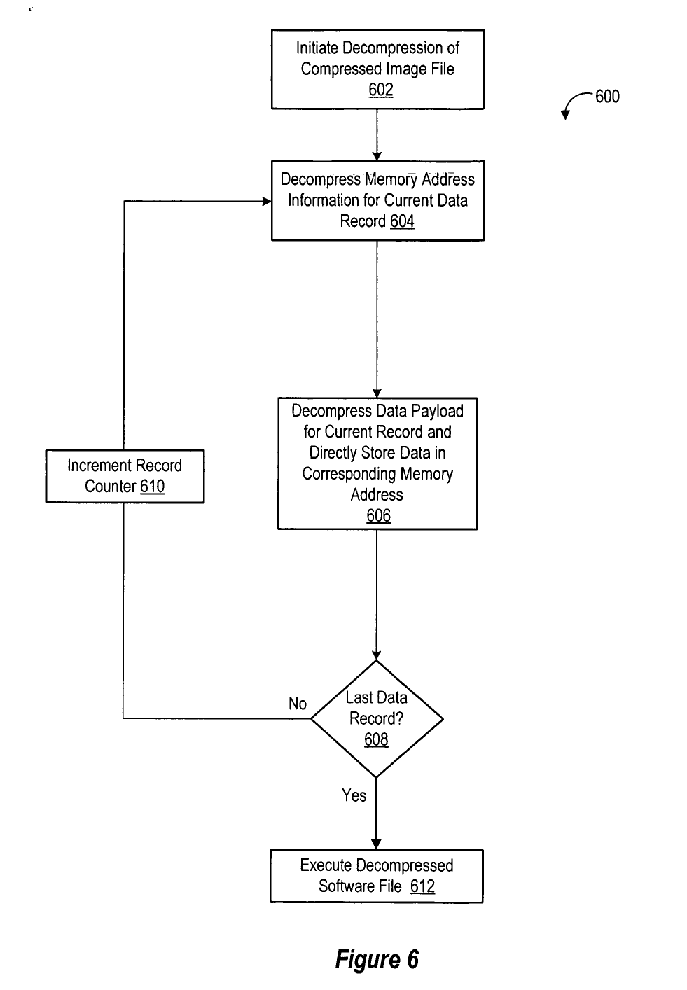

FIG. 6 is a flow chart illustration of the processing steps for implementing the method of the present invention. In step 602, the system initializes the decompression of the software image. In step 604, a portion of the current (initial) record is decompressed to obtain information relating to the destination memory address for the data payload. In step 606, the remaining data payload for the current record is decompressed is stored directly in the destination address for that payload. In step 608, a test is conducted to determine if the current record is the last record in the compressed image. If the result of the test conducted in step 608 indicates that the current record is the last record, processing proceeds to step 612 and the decompressed software image is executed. If, however, the result of the test conducted in step 610 indicates that the current record is not the last record, processing proceeds to step 610 where the record counter is incremented and steps 604-608 are repeated for the next record until all records in the compressed software image file have been decompressed and stored in their respective destination memory addresses.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A method for executing a compressed software file, comprising:
receiving a request to execute said compressed software file, wherein said compressed software file comprises a file header and a record comprising compressed data corresponding to a plurality of uncompressed data records;
decompressing a portion of said record containing information relating to a destination memory addresses for individual uncompressed data records in said plurality of uncompressed data records;
decompressing said compressed data to generate said plurality of uncompressed data records; and
using said destination addresses for said individual uncompressed data records to store said individual uncompressed data records in their respective memory destinations.

2. The method of claim 1, wherein said record comprises a plurality of record headers comprising data corresponding to the destination memory addresses of said individual uncompressed data records.

3. The method of claim 2, wherein said plurality of record headers further comprise data corresponding to the length of the data in said individual uncompressed data records

4. The method of claim 3, wherein said plurality of record headers further comprise a validation code to validate the data in said individual uncompressed data records.

5. The method of claim 4, wherein said compressed software file comprises an operating system.

6. A device comprising at least one recordable medium having stored thereon an initiation software file comprising executable instructions and data which, when executed by at least one processing device, cause the at least one processing device to:
execute a compressed software file, wherein said compressed software file comprises a file header and a record comprising compressed data corresponding to a plurality of uncompressed data records;
decompress a portion of said record containing information relating to a destination memory addresses for individual uncompressed data records in said plurality of uncompressed data records;
decompress said compressed data to generate said plurality of uncompressed data records; and
use said destination addresses for said individual uncompressed data records to store said individual uncompressed data records in their respective memory destinations.

7. The device of claim 6, wherein said record comprises a plurality of record headers comprising data corresponding to the destination memory addresses of said individual uncompressed data records.

8. The device of claim 7, wherein said plurality of record headers further comprise data corresponding to the length of the data in said individual uncompressed data records

9. The device of claim 8, wherein said plurality of record headers further comprise a validation code to validate the data in said individual uncompressed data records.

10. The device of claim 9, wherein said compressed software file comprises an operating system.

11. A method for executing a compressed software file, comprising:
receiving a request to execute said compressed software file, wherein said compressed software file comprises a file header and a plurality of compressed data records comprising compressed data corresponding to a plurality of uncompressed data records, each of said compressed data records comprising a compressed record header;
decompressing said compressed record headers for said plurality of compressed data records to obtain information relating to a destination memory address for individual uncompressed data records in said plurality of uncompressed data records;
decompressing said compressed data to generate said plurality of uncompressed data records; and
using said destination addresses for said individual uncompressed data records to store said individual uncompressed data records in their respective memory destinations.

12. The method of claim 11, wherein said record headers comprise data corresponding to the destination memory addresses of said individual uncompressed data records.

13. The method of claim 12, wherein said record headers further comprise data corresponding to the length of the data in said individual uncompressed data records

14. The method of claim 13, wherein said record headers further comprise a validation code to validate the data in said individual uncompressed data records.

15. The method of claim 14, wherein said compressed software file comprises an operating system.

16. A device comprising at least one recordable medium having stored thereon an initiation software file comprising executable instructions and data which, when executed by at least one processing device, cause the at least one processing device to:
execute said compressed software file, wherein said compressed software file comprises a file header and a plurality of compressed data records comprising compressed data corresponding to a plurality of uncompressed data records, each of said compressed data records comprising a compressed record header;
decompress said compressed record headers for said plurality of compressed data records to obtain information relating to a destination memory address for individual uncompressed data records in said plurality of uncompressed data records;
decompress said compressed data to generate said plurality of uncompressed data records; and
use said destination addresses for said individual uncompressed data records to store said individual uncompressed data records in their respective memory destinations.

17. The device of claim 16, wherein said record headers comprising data corresponding to the destination memory addresses of said individual uncompressed data records.

18. The device of claim 17, wherein said record headers further comprise data corresponding to the length of the data in said individual uncompressed data records

19. The device of claim 18, wherein said record headers further comprise a validation code to validate the data in said individual uncompressed data records.

20. The device of claim 19, wherein said compressed software file comprises an operating system.
